(19) United States
(12) Patent Application Publication
(10) Pub. No.: US 2012/0298776 A1
(43) Pub. Date: Nov. 29, 2012

(54) SELF-DEFENSE GAS SPRAY DEVICE

(76) Inventor: Sang-Up Yu, Seoul (KR)

(21) Appl. No.: 13/577,697

(22) PCT Filed: Feb. 7, 2011
(86) PCT No.: PCT/KR2011/000787

§ 371 Date: Aug. 8, 2012

(30) Foreign Application Priority Data
Feb. 8, 2010 (KR) 10-2010-0011342

(51) Int. Cl. B05B 1/14; F21L 4/00; B65D 83/00

(52) U.S. Cl. 239/311; 222/3; 222/4

(57) ABSTRACT

Disclosed is a self-defense gas spray device. The self-defense gas spray device sprays gas to a target so as to achieve self-defense goals. The self-defense gas spray device includes a flashlight member that flashes light to the target to which the gas is to be sprayed, while concentrating the light onto the target; and a gas spray member which evaporates a spray gas source contained therein into the gas and sprays the gas to the target while the light is being concentrated onto the target by the flashlight member. The disclosed self-defense gas spray device has advantages of spraying gas accurately onto a specific part of the target, for example, onto the face of the target, while blinding the eyes of the target in dark environment, such as at night.

### TECHNICAL FIELD

The present invention relates to a self-defense gas supply device.

### BACKGROUND ART

A user carries a self-defense gas spray device to spray tear liquid in the form of gas to a target, such as a burglar.

However, according to the conventional self-defense gas spray device, the gas may not readily strike on the target under dark environment, such as at night.

In addition, even if the user sprays the gas to the target after shining a flashlight onto the target under the dark environment, such as at night, the gas may not readily strike on the target.

Further, according to the conventional self-defense gas spray device, the gas is sprayed only in the form of a water stream because there are no other options for the spraying type of the gas, so it may leave many shortcomings when it is necessary to spray gas in other forms rather than the water stream form for the self-defense.

In addition, according to the conventional self-defense gas spray device, the amount of spray gas sources remaining in the conventional self-defense gas spray device may not be recognised from the outside.

### DISCLOSURE

### Technical Problem

An object of the present invention is to provide a self-defense gas spray device having the structure capable of accurately spraying gas to a target even in dark environment, such as at night.

Another object of the present invention is to provide a self-defense gas spray device having the structure capable of readily changing the spraying type of gas.

Still another object of the present invention is to provide a self-defense gas spray device having various functions, such as a burglar-proof function.

Still another object of the present invention is to provide a self-defense gas spray device having the structure allowing a user to readily recognize the amount of spray gas sources remaining in the self-defense gas spray device.

### Technical Solution

According to one aspect of the present invention, the self-defense gas spray device that sprays gas to a target for self-defense includes a flashlight member that flashes light to the target to which the gas is to be sprayed, while concentrating the light onto the target; and a gas spray member which evaporates a spray gas source contained therein into the gas and sprays the gas to the target while the light is being concentrated onto the target by the flashlight member.

### Advantageous Effect

The self-defense gas spray device according to one aspect of the present invention can concentrate the light, which is emitted from a light emission lamp of the flashlight member, to the target through a focusing lens, and the gas spray member can spray the gas to the target in a state that the light is concentrated onto the target. Thus, the self-defense gas spray device can accurately spray the gas onto a specific part of the target, for example, onto the face of the target, while blinding the eyes of the target in dark environment, such as at night.

According to another aspect of the present invention, the flashlight member and the gas spray member are inclined with respect to each other by a predetermined angle such that the travelling direction of the light concentrated onto the target from the flashlight member matches with the travelling direction of the gas sprayed from the gas spray member, so the self-defense gas spray device according to another aspect of the present invention can accurately strike the gas to the target in a state that the light is concentrated onto the target.

According to still another aspect of the present invention, the spraying type of the gas sprayed from a nozzle unit can be changed in the form of a water stream or smog by rotating a spraying type change part, so the spraying type of the gas can be rapidly and readily changed.

The self-defense gas spray device according to still another aspect of the present invention includes an alarm member. Thus, at least one of alarm light and alarm sound may be generated from the alarm member upon emergency, so the self-defense gas spray device may have the alarm function.

According to still another aspect of the present invention, the alarm member may include a vibration detecting sensor. In this case, if vibration of the alarm member is detected by the vibration detecting sensor, alarm sound and alarm light may be generated from an alarm sound generator and an alarm light generator, so the self-defense gas spray device may have the burglar-proof function.

The self-defense gas spray device according to still another aspect of the present invention includes a transparent window, a scale mark and a light emission lamp, so a user can readily recognize the amount of spray gas sources remaining in a spray gas receptacle.

### DESCRIPTION OF DRAWINGS

FIG. 1 is a sectional view showing the structure of a self-defense gas spray device according to one embodiment of the present invention;

FIG. 2 is an enlarged view of an A portion shown in FIG. 1;

FIG. 3 is an enlarged view of a B portion shown in FIG. 1;

FIG. 4 is a perspective view showing an exhaust part of a self-defense gas spray device according to one embodiment of the present invention;

FIG. 5 is a perspective view showing a spraying type change part of a self-defense gas spray device according to one embodiment of the present invention;

FIG. 6 is an enlarged view of a C portion shown in FIG. 1;

FIG. 7 is a perspective view showing an installation state of a vibration detecting sensor constituting a self-defense gas spray device according to one embodiment of the present invention;

FIG. 8 is a sectional view showing a vibrator and an electrode, which are separated from each other, of a vibration detecting sensor constituting a self-defense gas spray device according to one embodiment of the present invention; and

FIG. 9 is a sectional view showing a vibrator and an electrode, which make contact with each other, of a vibration detecting sensor constituting a self-defense gas spray device according to one embodiment of the present invention.

### BEST MODE

### Mode for Invention

Hereinafter, a self-defense gas spray device according to one embodiment of the present invention will be described in detail with reference to accompanying drawings.

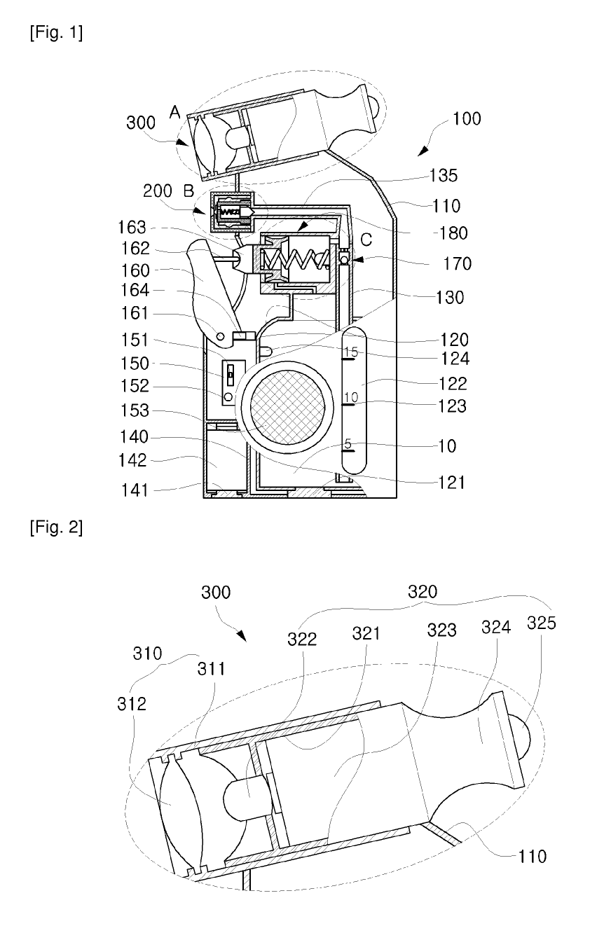

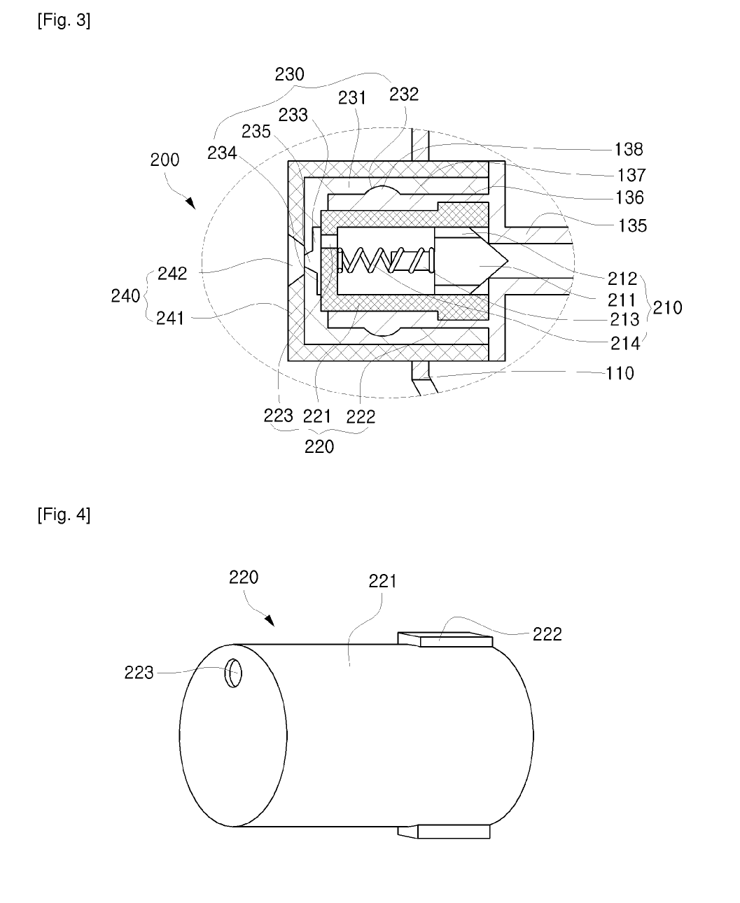

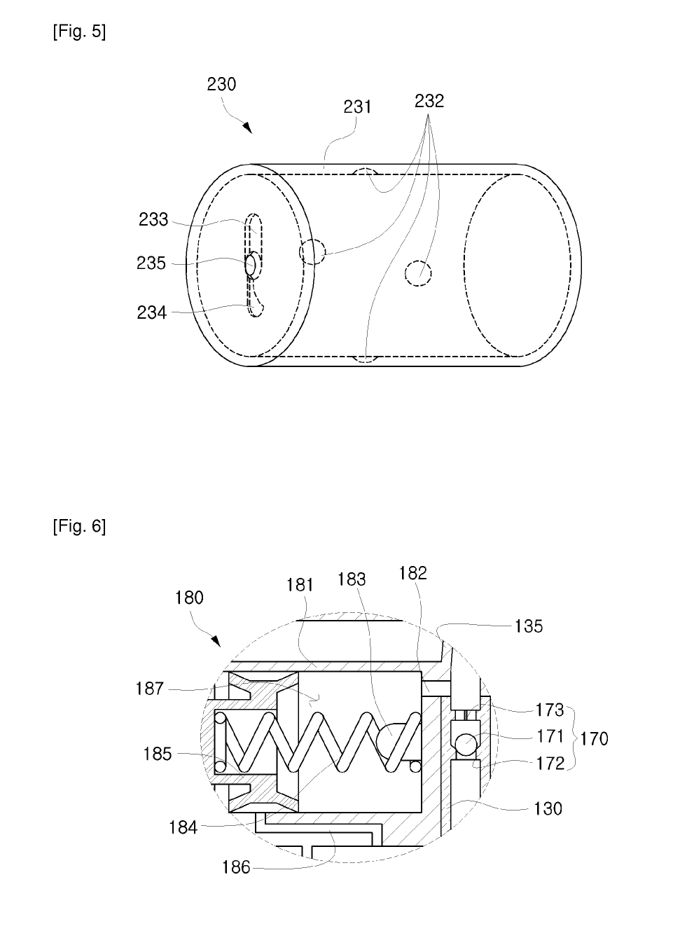

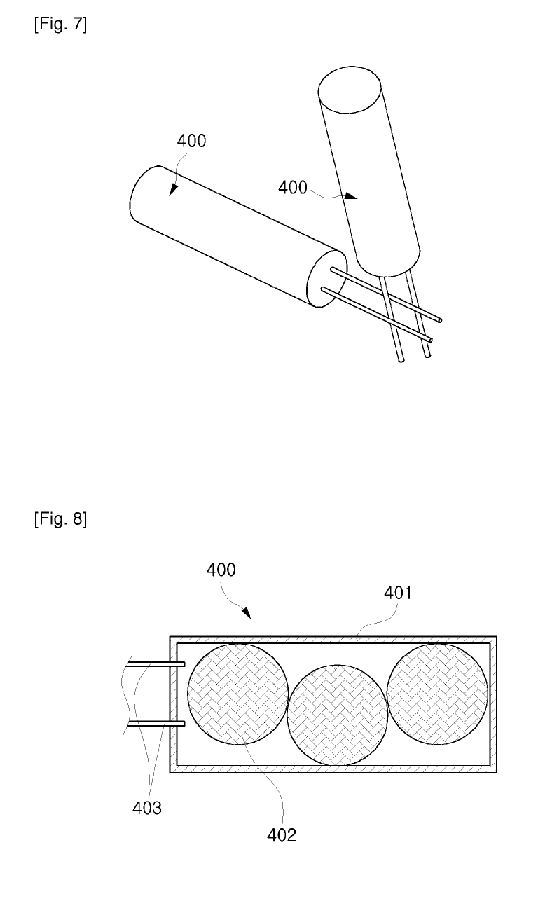

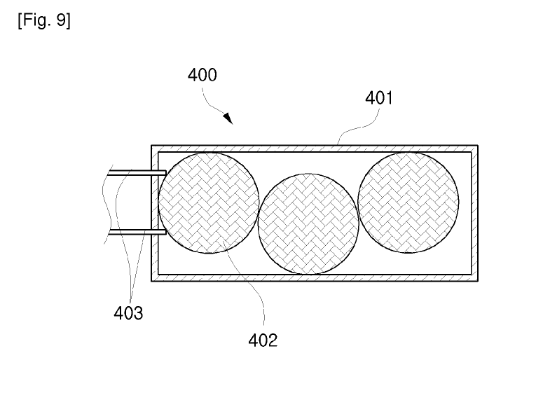

FIG. 1 is a sectional view showing the structure of a self-defense gas spray device according to one embodiment of the present invention, FIG. 2 is an enlarged view of an A portion shown in FIG. 1, FIG. 3 is an enlarged view of a B portion shown in FIG. 1, FIG. 4 is a perspective view snowing an exhaust part of a self-defense gas spray device according to one embodiment of the present invention, FIG. 5 is a perspective view showing a spraying type change part of a self-defense gas spray device according to one embodiment of the present invention, FIG. 6 is an enlarged view of a C portion shown in FIG. 1, FIG. 7 is a perspective view showing an installation state of a vibration detecting sensor constituting a self-defense gas spray device according to one embodiment of the present invention, FIG. 8 is a sectional view showing a vibrator and an electrode, which are separated from each other, of a vibration detecting sensor constituting a self-defense gas spray device according to one embodiment of the present invention, and FIG. 9 is a sectional view showing a vibrator and an electrode, which make contact with each other, of a vibration detecting sensor constituting a self-defense gas spray device according to one embodiment of the present invention.

Referring to FIGS. 1 to 9, the self-defense gas spray device 100 according to one embodiment of the present invention includes a body 110, a nozzle unit 200 and a flashlight member 300 in order to spray gas to the target for self-defense. The target may be a person treating a user possessing the self-defense gas spray device 100.

The user may grip the body 110 using a hand. The body 110 is provided therein with a spray gas source receptacle 120, a liquid passage pipe 130, a gas passage pipe 135, a battery receptacle 140, a control member 150, a ball receptacle 170, a pumping member 180, and the nozzle unit 200. A front portion of the nozzle unit 200 is exposed to the outside through a front portion of the body 110.

The spray gas source receptacle 120, the liquid passage pipe 130, the gas passage pipe 135, the ball receptacle 170, the pumping member 180, and the nozzle unit 200 may be defined as a gas spray member that evaporates the spray gas source received in the spray gas source receptacle 120 and sprays the gas to the target in a state that the light is concentrated onto the target by the flashlight member 300.

The body 110 is provided with an actuating lever 160, which is rotatable within a predetermined angle range by an actuating lever rotating shaft 161.

The spray gas source receptacle 120 is provided therein with a spray gas source 10, such as tear liquid.

The spray gas source receptacle 120 and the body 110 are formed with a transparent window 122, so the user can recognise the amount of the spray gas source 10 in the spray gas source receptacle 120 from the outside through the transparent window 122.

The transparent window 122 is formed with a scale mark 123, so the user can measure the amount of the spray gas source 10 in the spray gas source receptacle 120 based on the scale mark 123.

A light emission lamp 124 is provided in the spray gas source receptacle 120. As the light emission lamp 124 emits the light, the light is irradiated onto the spray gas source 10 in the spray gas source receptacle 120, so the amount of the spray gas source 10 in the spray gas source receptacle 120 can be recognized from the outside through the transparent window 122 even in dark environment, such as at night.

As described above, the amount of the spray gas source 10 contained in the spray gas source receptacle 120 can be readily recognized through the transparent window 122, the scale mark 123 and the light emission lamp 124.

A refill hole is formed at a bottom of the spray gas source receptacle 120 to allow the user to refill the spray gas source 10 into the spray gas source receptacle 120 and a plug 121 is detachably installed in the refill hole. Thus, the user refills the spray gas source 10 into the spray gas source receptacle 120 by detaching the refill plug 121 from the refill hole and then fits the refill plug 212 into the refill hole.

The liquid passage pipe 130 extends into the spray gas source receptacle 120 and the spray gas source 10 contained in the spray gas source receptacle 120 moves up along the liquid passage pipe 130. The liquid passage pipe 130 is connected to the pumping member 180 to supply the spray gas source 10 to the pumping member 180.

The ball receptacle 170 is formed on the liquid passage pipe 130 and a spherical ball 171 is movably accommodated in the ball receptacle 170. The ball 171 is moved between a lower ball blocking part 172, which is provided at a lower portion of the ball receptacle 170, and an upper ball blocking part 173, which is provided at an upper portion of the ball receptacle 170.

In detail, if the spray gas source 10 moves up along the liquid passage pipe 130, the ball 171 also moves up to the upper ball blocking part 173. At this time, even if the ball 171 makes contact with the upper ball blocking part 173, the spray gas source 10 may move up by passing through the ball receptacle 170 via a plurality of holes formed in the upper ball blocking part 173.

Meanwhile, if the gas formed through the expansion of the spray gas source 10 is discharged out of the pumping member 180, the ball 171 moves down to the lower ball blocking part 172 and makes contact with the lower ball blocking part 172. As the ball 171 makes contact with the lower ball blocking part 172, the lower ball blocking part 172 is clogged by the ball 171, so the gas moves up through the gas passage pipe 135 without passing through the ball receptacle 170.

The gas passage pipe 135 connects the pumping member 180 with the nozzle unit 200, so the gas generated in the pumping member 180 may be supplied to the nozzle unit 200.

One side part of the actuating lever 160, that is, a lower portion of the actuating lever 160 is rotatably connected to the body 110 by the actuating lever rotating shaft 161. In addition, a pressing protrusion 162 may protrude from the other side part of the actuating lever 160, that is, an upper portion of the actuating lever 160 spaced apart from the one side part of the actuating lever 160 connected to the actuating lever rotating shaft 161. If the actuating lever 160 is pressed down by external force, the pressing protrusion 162 presses a pressed member 163, so a piston of the pumping member 180 connected to the pressed member 163 is moved.

Since the one side part of the actuating lever 160 is connected to the body 110 by the actuating lever rotating shaft 161 and the other side part of the actuating lever 160 presses the pumping member 180, the actuating lever 160 is pressed while being pulled by an index finger of the user in a state that the body 110 is gripped by the hand of the user, so external force is applied to the actuating lever 160 to operate the pumping member 180.

A locking part 164 is installed in the body 110 in the vicinity of the actuating lever rotating shaft 161. The locking part 164 is looked with the looking lever 160 in the vicinity of the actuating lever rotating shaft 161, thereby preventing the actuating lever 164 from being operated even if the external force is applied to the actuating lever 160.

The locking part 164 may move such that the locking part 164 can be looked with or released from the actuating lever 160. If the user moves the locking part 164 from the actuating lever 160, the locking of the actuating lever 160 is released so that the actuating lever 160 can be operated.

The pumping member 180 includes a pumping member body 181, a spray gas source inlet port 182, a protrusion 183, an elastic member 184, the piston 185, an external air inlet pipe 186 and an expansion chamber 187.

The piston 185 is movably installed in the pumping member body 181. The piston 185 is connected to the pressed member 163, so the piston 185 may move as the actuating lever 160 is operated.

The protrusion 183 protrudes from the pumping member body 181 and is locked with the elastic member 164. One end of the elastic member 184 is locked with the protrusion 183 and the other end of the elastic member 184 is locked with the piston 185, thereby applying elasticity to the piston 185. Thus, when the piston 185 is pressed by the actuating lever 160, the elastic member 184 is compressed while accumulating the restoring force. Then, if the external force is released from the actuating lever 160, the piston 185 returns to its initial position due to the restoring force of the elastic member 134.

The expansion chamber 187 is defined by the pumping member body 161 and the piston 185. An upper portion of the liquid passage pipe 130 and a lower portion of the gas passage pipe 135 are connected to the expansion chamber 187 through the spray gas source inlet port 182. Thus, the spray gas source 10 moved up through the liquid passage pipe 130 may be introduced into the expansion chamber 187 through the spray gas source inlet port 182 and the gas generated in the expansion chamber 137 is introduced into the gas passage pipe 135 through spray gas source inlet port 182. After the piston 135 has moved to the position adjacent to the protrusion 183, if the piston 185 is moved to be spaced apart from the protrusion 183, the expansion chamber 187 is expanded corresponding to the movement of the piston 185, so the spray gas source 10 introduced into the expansion chamber 187 is expanded and changed into the gas.

The external air inlet pipe 186 connects the pumping member body 131 with the spray gas source receptacle 120 in such a manner that external air can be introduced into the spray gas source receptacle 120.

In a state that the actuating lever 160 has not been pressed, that is, in a state that the expansion chamber 187 has been maximally expanded, the piston 185 blocks the external air inlet pipe 186, so the external air may not be introduced through the external air inlet pipe 186. In contrast, if the actuating lever 160 is pressed, the expansion chamber 187 is contracted, so the piston 185 is moved and the external air inlet pipe 186 is open. Thus, the external air is introduced into the spray gas source receptacle 120 through the external air inlet pipe 186.

As described above, the pumping member 180 has the function of pumping the external air as well as the function of evaporating the spray gas source 10.

The nozzle unit 200 sprays the gas, which is generated in the pumping member 180, to the outside and includes a check valve 210, an exhaust part 220, a spraying type change part 230, and a spray nozzle part 240.

Reference numeral 137 represents a gas passage pipe extension part that extends in the front direction from an expansion part of an end portion of the gas passage pipe 135, reference numeral 136 represents a fixing groove formed at an inner surface of the gas passage pipe extension part 137, and reference numeral 138 represents a locking protrusion formed at an outer surface of the gas passage pipe extension part 137.

The exhaust part 220 includes an exhaust part body 221 having a cylindrical shape and an exhaust hole 223 formed at a front portion of the exhaust part body 221 to exhaust the gas supplied through the gas passage pipe 135. A fixing protrusion 222 fixed to the fixing groove 236 is formed on the outer surface of the exhaust part body 221.

The check valve 210 is movably installed in the exhaust part body 221. The check valve 210 includes a check valve body 211 having a sharp structure to clog the gas passage pipe 135, a gas hole 212 for allowing gas to flow through the check valve body 211 when the gas is introduced as the check valve body 211 is spaced apart from the gas passage pipe 135, an extension part 213 extending from the check valve body 211 toward the exhaust hole 223, and an elastic member 214 having one side connected to the extension part 213 and the other side connected to the exhaust part body 221.

As the gas is introduced through the gas passage pipe 135, the check valve 210 is moved to open the gas passage pipe 135. At this time, the elastic member 214 is compressed while accumulating restoring force. If the gas supply is stopped, the check valve 210 closes the gas pas sage pipe 135 due to the restoring force of the elastic member 214. Thus, the backflow of the gas through the gas passage pipe 135 can be prevented.

The spraying type change part 230 includes a body 231, locking grooves 232 formed in the inner surface of the body 231 and locked with the locking protrusion 138, a water stream type spray hole 233 formed at a front portion of the body 231, a smog type spray hole 234 formed at the front portion of the body 231, and a conversion exhaust hole 235.

The water stream type spray hole 233 is for spraying gas, which has been exhausted through the exhaust hole 223, in the form of the water stream. To this end, as shown in FIG. 5, the water stream type spray hole 233 is elongated with a uniform width.

The smog type spray hole 234 is for spraying gas, which has been exhausted through the exhaust hole 223, in the form of smog. To this end, as shown in FIG. 5, the smog type spray hole 234 is elongated in the form of a blade, a width of which is gradually enlarged outward to generate a swirl flow.

The gas that has been moved through one of the water stream type spray hole 233 and the smog type spray hole 234 is sprayed through the conversion exhaust hole 235. In the front portion of the body 231, a region between the water stream type spray hole 233 and the smog type spray hole 234 on the basis of the conversion exhaust hole 235 may be defined as a blank that blocks the exhaust hole 223.

As the body 231 of the spraying type change part is relatively rotated with respect to the exhaust part body 221 by the external force, one of the wafer stream type spray hole 233, the smog type spray hole 234 and the blank may face the exhaust hole 223. If the water stream type spray hole 233 faces the exhaust hole 223, the gas may be sprayed in the form of the water stream. If the smog type spray hole 234 faces the exhaust hole 223, the gas may be sprayed in the form of the smog. In addition, if the blank faces the exhaust hole 223, the gas may not be sprayed.

In order to allow the body 231 of the spraying type change part to stop the relative rotation with respect to the exhaust part body 221 in a state that one of the water stream type spray hole 233, the smog type spray bole 234 and the blank precisely faces the exhaust hole 223, one of the locking grooves 232 formed in the body 231 of the spraying type change part is engaged with the locking protrusion 138 when each of the water stream type spray hole 233, the smog type spray hole 234 and the blank faces the exhaust hole 223.

The locking grooves 232 are engaged with the locking protrusion 138 and they are defined as a concavo-convex section.

Meanwhile, when the blank faces the exhaust hole 223, the gas is not sprayed from the gas spray member, so the blank locks the gas spray member together with the locking member 164. Thus, the spray gas source 10 can be prevented from being unintentionally leaked from the gas spray member.

The spray nozzle part 240 includes a spray nozzle body 241 and a spray nozzle hole 242 formed in the spray nozzle body 241. The gas supplied from the conversion exhaust hole 235 in the form of the water stream, or smog can be sprayed to the outside through the spray nozzle hole 242.

The spraying type change part 230 can be rotated after removing the spray nozzle part 240.

Since the spraying type change part 230 is formed as described above, the spraying type of the gas sprayed from the nozzle unit 200 can be changed into the form of the water stream or smog by rotating the spraying type change part 230, so the spraying type of the gas can be rapidly and readily changed.

The battery receptacle 140 accommodates a battery 142 therein. The battery 142 can be exchanged with new one by detaching a battery receptacle plug 141. The battery 142 supplies electric energy to the light emission lamp 124, an alarm light generator 152 and an alarm sound generator 153.

The alarm light generator 152 generates alarm light and the alarm sound generator 153 generates alarm sound upon emergency. The alarm light generator 152 and the alarm sound generator 153 may be selectively used. The alarm light generator 152 and the alarm sound generator 153 may be defined as an alarm member.

The alarm member generates at least one of the alarm light and alarm sound.

As described above, since the alarm member is installed, at least one of the alarm light and alarm sound can be generated from the alarm member upon emergency, so the self-defense gas spray device 100 may have the function of the alarm member.

Meanwhile, if the alarm member includes a vibration detecting sensor 400, the alarm light generator 152 and the alarm sound generator 153 may generate the alarm light and the alarm sound, respectively, as the vibration detecting sensor 400 detects the vibration of the alarm member. Thus, the self-defense gas spray device 100 may have the burglar-proof function.

The vibration detecting sensor 400 includes a vibration detecting sensor case 401 having a hollow cylindrical structure, a vibrator 402 installed in the vibration detecting sensor case 401, and a pair of electrodes 403 extending by passing through the vibration detecting sensor case 401 while making contact with the vibrator 402.

The vibrator 402 includes a ball made from a conductive metallic material and a plurality of vibrators 402 are installed in the vibration detecting sensor case 401 to sensitively detect external impact.

On end of the electrode 403 is exposed to the interior of the vibration detecting sensor case 401 and the other end of the electrode 403 is connected to the control member 150. Thus, as shown in FIG. 9, if the vibrator 402 makes contact with the pair of electrodes 403 due to the external impact, electricity may flow through the electrodes 403, so that the control member 150 connected to the electrodes 403 may recognize that the vibration defecting sensor 400 detects the vibration.

A plurality of vibration detecting sensors 400 may be installed in the body 110 of the self-defense gas spray device 100. As shown in FIG. 7, the vibration detecting sensors 400 may be directed in different directions. For instance, one vibration detecting sensor 400 may be arranged in the transverse direction of the self-defense gas spray device 100, and the ether vibration detecting sensor 400 may be inclined at a predetermined angle with respect to one vibration detecting sensor 400 arranged in the transverse direction of the self-defense gas spray device 100. Thus, the vibration detecting sensors 400 may detect the vibration in various directions of the self-defense gas spray device 100, preferably, in ail directions of the self-defense gas spray device 100.

Since the vibration detecting sensors 400 have the above structure, the vibration detecting sensors 400 may have a small size with superior detection performance.

The control member 150 is provided with various circuits. A manipulation part 151 can be installed on the control member 150. The user can operate the alarm member and the light emission lamp 124 by manipulating the manipulation part 151.

The flashlight member 300 flashes light to the target to which gas is to be sprayed from the self-defense gas spray device 100, while concentrating the light onto the target. The flashlight member 300 may be provided at an upper portion of the gas spray member.

The flashlight member 300 includes an outer flashlight tube 310 and an inner flashlight tube 320.

A body 311 of the outer flashlight tube 310 has a cylindrical structure and a focusing lens 312, such as a convex lens, is installed in the body 311.

A body 321 of the inner flashlight tube 320 has a cylindrical structure such that the body 321 of the inner flashlight tube 320 can be fitted into the body 311 of the outer flashlight tube 310. That is, the body 321 of the inner flashlight tube 320 is slidably inserted into the body 311 of the outer flashlight tube 310. The body 321 is provided with a light emission lamp 322 directed toward the focusing lens 312.

A battery 323 is inserted into the body 321 of the inner flashlight tube 320 to supply electric energy to the light emission lamp 322.

A grip part 324 is provided at a rear portion of the inner flashlight tube 320 to allow the user to grip the inner flashlight tube 320. A switch 325 is provided in the grip part 324 to turn on/off the light emission lamp 322.

If the inner flashlight tube 320 is moved in the outer flashlight tube 310 such that the light emission lamp 322 is spaced part from, the focusing lens 312, that is, if the inner flashlight tube 320 is moved out of the outer flashlight tube 310, the light emitted from the light emission lamp 322 can be concentrated onto the target through the focusing lens 312.

In contrast, if the inner flashlight tube 320 is moved in the outer flashlight tube 310 such that the light emission lamp 322 approaches the focusing lens 312, that is, if the inner flashlight tube 320 is moved into the outer flashlight tube 310, the light emitted from the light emission lamp 322 may be spread through the focusing lens 312, thereby widely flashing the forward area of the self-defense gas spray device 100.

As described above, the light emitted from the light emission lamp 322 in the flashlight member 300 can be concentrated onto the target through the focusing lens 312. In addition, in this state, the gas spray member sprays the gas toward the target, so the self-defense gas spray device 100 can accurately spray the gas onto a specific part of the target, for example, onto the face of the target, while blinding the eyes of the target in dark environment, such as at night.

Meanwhile, the flashlight member 300 and the gas spray member may be inclined with respect to each other by a predetermined angle such that the travelling direction of the light concentrated onto the target from the flashlight member 300 matches with the travelling direction of the gas sprayed from the gas spray member. For instance, when the gas is sprayed to the target located, in the forward area of the self-defense gas spray device 100 at a distance of 3 m, the flashlight member 300 and the gas spray member may be inclined with respect to each other at an angle of 6° such that the light of the flashlight member 300 may reach the specific point of the target together with the gas sprayed from the gas spray member.

As described above, since the flashlight member 300 and the gas spray member are inclined with respect, to each other by a predetermined angle such that the travelling direction, of the light concentrated onto the target from the flashlight member 300 matches with the travelling direction of the gas sprayed from the gas spray member, the gas can be accurately sprayed onto the target, in a state that the light is concentrated onto the target remote from the self-defense gas spray device 100 by a predetermined distance.

Hereinafter, the operation of the self-defense gas spray device 100 will be described.

First, the spray gas source 10 is accommodated in the spray gas source receptacle 120 and the locking state of the locking part 164 is released. Then, in a state that one of the water stream type spray hole 233 and the smog type spray hole 234 of the spraying type change part 230 is selected to face the exhaust hole 223, if the user presses the actuating lever 160 while pulling the actuating lever 160 using the index finger by gripping the body of the self-defense gas spray device, the piston 185 is moved into the pumping member body while opening the external air inlet pipe 186. Thus, the external air is introduced into the spray gas source receptacle 120 through the external air inlet pipe 186.

After that, if the user release the force applied to the actuating lever 160, the piston 185 retreats while closing the external air inlet pipe 186 so that the expansion chamber 187 is expanded. Thus, due to the difference in atmospheric pressure between the interior of the spray gas source receptacle 120, into which the external air is introduced, and the interior of the expansion chamber 187, the spray gas source 10 accommodated in the spray gas source receptacle 120 is moved up through the liquid passage pipe 130.

Then, the spray gas source 10 is introduced into the expansion chamber 187 through the ball receptacle 170. In this process, the spray gas source 10 is expanded and evaporated into the gas.

After that, if the user again presses the actuating lever 160 while pulling the actuating lever 160, the gas is supplied to the nozzle unit 200 through the gas passage pipe 135. At this time, the external air inlet pipe 186 is open again, so the external air is again introduced, into the spray gas source receptacle 120. Thus, the gas spray member can continuously spray the gas.

The gas introduced into the nozzle unit 200 is sprayed to the target through the nozzle unit 200.

At this time, if the light concentrated onto the target flashes the target, the user can readily and accurately spray the gas to the target.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

### INDUSTRIAL APPLICABILITY

According to one aspect of the present invention, the self-defense gas spray device can accurately spray the gas to the target even in dark environment, such as at night, so the present invention may represent high industrial applicability.

1. A self-defense gas spray device that sprays gas to a target for self-defense, the self-defense gas spray device comprising:
a flashlight member that flashes light to the target to which the gas is to be sprayed, while concentrating the light onto the target; and
a gas spray member which evaporates a spray gas source contained therein into the gas and sprays the gas to the target while the light is being concentrated onto the target by the flashlight member.

2. The self-defense gas spray device of claim 1, wherein the flashlight member includes an outer flashlight tube equipped with a focusing lens and an inner flashlight tube movably inserted into the outer flashlight tube and equipped with a light emission lamp, and the light emitted from the light emission lamp is concentrated onto the target through the focusing lens when the inner flashlight tube is moved in the outer flashlight tube such that the light emission lamp is spaced apart from the focusing lens.

3. The self-defense gas spray device of claim 1, wherein the flashlight member and the gas spray member are inclined with respect to each ether by a predetermined angle such that a travelling direction of the light concentrated onto the target from the flashlight member matches with a travelling direction of the gas sprayed from the gas spray member.

4. The self-defense gas spray device of claim 1, wherein the gas spray member comprises:
a pumping member for evaporating the spray gas source; and
a nozzle unit for spraying the gas evaporated in the pumping member,
wherein the nozzle unit comprises:
a gas passage pipe that serves as a supply passage for the gas evaporated in the pumping member;
an exhaust part formed with an exhaust hole to exhaust the gas supplied through the gas passage pipe; and
a spraying type change part including a water stream type spray hole for spraying the gas, which is exhausted through the exhaust hole, in a form of a water stream, a smog type spray hole for spraying the gas, which is exhausted through the exhaust hole, in a form of a smog, and a blank which is a blockade part between the water stream type spray hole and the smog type spray hole,
wherein one of the water stream type spray hole, the smog type spray hole and the blank faces the exhaust hole as the spraying type change part is rotated relative to the exhaust part,
wherein concavo-convex sections are formed in the gas passage pipe and the spraying type change part, respectively, and
wherein the concavo-convex sections are engaged with each other to stop the rotation of the spraying type change part relative to the exhaust part such that one of the water stream type spray hole, the smog type spray hole and the blank accurately faces the exhaust hole when each of the water stream type spray hole, the smog type spray hole and the blank is located to face the exhaust hole.

5. The self-defense gas spray device of claim 4, wherein the gas spray member further comprises:
an actuating lever to which external force is applied to operate the pumping member; and
a locking part for locking the actuating lever to prevent the actuating lever from being operated even if the external force is applied to the actuating lever,
wherein the gas is not sprayed from the gas spray member when the blank faces the exhaust hole, so the blank serves as a locking device for the gas spray member together with the locking part.

6. The self-defense gas spray device of claim 1, wherein the gas spray member comprises:
a pumping member for evaporating the spray gas source; and
an actuating lever to which external force is applied to operate the pumping member,
wherein one side part of the actuating lever is rotatably connected to a body of the gas spray member by an actuating lever rotating shaft, and
wherein, the actuating lever is pressed while being pulled by an index finger of a user in a state that the body of the gas spray member is gripped by a hand of the user, so external force is applied to an opposite side part of the actuating lever, which is spaced part from the one side part of the actuating lever connected to the actuating lever rotating shaft, so that the pumping member is operated.

7. The self-defense gas spray device of claim 1, wherein the gas spray member comprises:
a spray gas source receptacle for receiving the spray gas source therein;
a transparent window for allowing a user to recognize an amount of the spray gas source received in the spray gas source receptacle from an outside;
a scale mark for measuring the amount of the spray gas source received in the spray gas source receptacle; and
a light emission lamp for emitting the light to the spray gas source received in the spray gas source receptacle.

8. The self-defense gas spray device of claim 7, wherein a refill hole is formed in the spray gas source receptacle to allow the user to refill the spray gas source into the spray gas source receptacle, and a detachable refill hole plug is installed in the refill hole.

9. The self-defense gas spray device of claim 1, further comprising an alarm member for generating at least one of an alarm sound and an alarm light.

10. The self-defense gas spray device of claim 9, wherein the alarm member comprises a vibration detecting sensor, and the alarm member generates at least one of the alarm sound and the alarm light as the vibration detecting sensor detects vibration of the alarm member.

11. The self-defense gas spray device of claim 10, wherein the vibration detecting sensor comprises:
a vibration detecting sensor case having a hollow interior;
a vibrator installed in the vibration detecting sensor case; and
an electrode making contact with the vibrator to detect the vibration.

12. The self-defense gas spray device of claim 10, wherein a plurality of vibration detecting sensors are arranged while being directed in directions different from each other.
